(19) United States
(12) Patent Application Publication
(10) Pub. No.: US 2007/0210985 A1
(43) Pub. Date: Sep. 13, 2007

(54) Three dimensional imaging system

(76) Inventor: George R. Royer, Toledo, OH (US)

Correspondence Address: George R. Royer, Suite 416, 316 N. Michigan Street, Toledo, OH, 43614, US

(21) Appl. No.: 11/373,593

(22) Filed: Mar. 13, 2006

(51) Int. Cl. G09G 3/14

(52) U.S. Cl. 345/46

(57) ABSTRACT

The subject apparatus is a three dimensional imaging system adapted to capture an actual object image from one location to be transmitted to a remote location for a continuous duplication of such image at a remote location, generally comprising an electrical system of light sensors dispersed above and laterally relative to the actual object to be photographed, such sensors being adapted to detect and sense the location, movement, shape and coloration and other attributes of the object image, each such sensors being capable of capturing a distinct and different aspect or feature of the actual object. The sensory and reproduction means at a distant location is equipped with an electrical means to detect and relay a sensual signal to a three dimensional physical matrix of lighted means to capture the image in the physical matrix through lighting of such members.

### DISCUSSION OF PRIOR ART AND BACKGROUND OF INVENTION

Systems adapted to capture three dimensional images and project such images at a remote location are known, and fall within the general category of optical or visual systems that are adapted to capture and duplicate three dimensional images. In this respect, there is a limited array of systems or methods wherein the image of the three dimensional of an object can be reproduced away and independently of the subject invention. Moreover, almost all the existing systems do not have methodology to produce an actual and a true independent three dimensional production of the image. More specifically, most three dimensional imaging systems in effect or known today do not produce a true three dimensional image that can be viewed from all directions in a simultaneous manner by a group of people surrounding the image reproduced image. In particular, as stated there are several three dimensional viewing techniques that exist, most of which have limitations that do not provide adequate three dimensional viewing from any viewing perspective or which have other limitations such as the need to use a central focusing object, which detracts from the viewing process.

Integral photography is a process of recording a full spatial image on a photographic plate. Most of integral photography involves use of multiple eye lens sheet, and places a photographic plate at the focal plane of such lenses for expose to light from an object, and imprint record on such photographic plate a larger number of small pictures of the object all from various directions.

Upon development of the photographic plate, the negative pictures are transformed to a positive one if necessary, all positions the positive picture at precisely the same position as before, and illuminate it from the rear.

The recorded optical information is as to the shape and color of the object seen from the right. Therefore, in reconstruction, an observer on the left will observe a so-called psuedoscopic image, that is, an image inverted in its depth. For example, what the observer will see as the face of a person is something like the back surface of a death mask painted in the original colors, which is not desirable.

As to holography, in an ordinary photograph, what is recorded at a point upon the photographic plate is the brightness of the image at that point. In an integral photograph, what is recorded at a point is the brightness of the image at that point is the brightness of the image is the premise for recording a spatial image upon a flat recording material.

In integral photography, a fine lens sheet is used for director-selective recording of the image. The holography to be described in this section uses, instead of a lens sheet, a tremendous number of diffraction gratings made upon a flat recording material as interference fringes. In the recording process of holography, a good “coherent” light source is used to make these interference fringes. In the reconstruction process the diffraction gratings are then illuminated by monochromatic light, and they diffract the illuminating light beam to form a wavefront similar to the originally recorded wavefront similar to the originally recorded wavefront from the object. Holography has certain difficulties and drawbacks for projecting three dimensional objects.

Integral photography is a process of recording a full spatial three dimensional image on a photographic plate. Most of integral photography involves use of multiple eye lens sheet, and places a photographic plate at the focal plane of such lenses for expose to light from an object, and imprint record on such photographic plate a larger number of small pictures of the object all from various directions. Upon development of the photographic plate, the negative pictures are transformed to a positive one if necessary, all positions the positive picture at precisely the same position as before, and illuminate it from the rear.

The use of holograph has disadvantages, as stated below:
(a) A darkened room is needed for recording a hologram.
(b) The object should be still
Usually a human is not the object of holography for two reasons. First, one for the necessary exposure time the person must remain still except when a special pulse laser is used. Also, laser-light illumination is often dangerous for human eyes.
(c) From ordinary holograms only monochromatic images can be projected.
(d) There is speckle noise and modulating noise.
(e) In the reconstruction process, efficiency is generally good.

### OBJECTS OF THE INVENTION

It is an object of the subject invention to produce an improved three dimensional viewing process;

Another object of the subject invention is to provide an improved system for recording a three dimensional view and transmitting such view to a remote location;

Yet another object of the subject invention is to set forth a system for providing and transmitting a representation of a three dimensional image;

Other and further object of the subject invention will become apparent from a reading of the specifications in conjunction with the claims and drawings.

### DESCRIPTION OF THE DRAWINGS

FIG. 1 is an elevational view showing the reproduction matrix of the subject invention.

FIG. 2 is a perspective view of the image capturing mechanisms surrounding stages with objects thereon to be reproduced three dimensionally.

FIG. 3 is a top elevational view of the storage area.

FIG. 4 is a schematic view of a multifaceted image capturing device.

### DESCRIPTION OF GENERAL EMBODIMENT AND SUMMARY OF INVENTION

The subject apparatus is a three dimensional imaging system adapted to capture an actual object image from one location to be transmitted to a remote location for a continuous duplication of such image at a remote location, generally comprising an electrical system of light sensors dispersed above and laterally relative to the actual object to be photographed, such sensors being adapted to detect and sense the location, movement, shape and coloration and other attributes of the object image, each such sensors being capable of capturing a distinct and different aspect or feature of the actual object. The sensory and reproduction means at a distant location is equipped with an electrical means to detect and relay a sensual signal to a three dimensional physical matrix of lighted means to capture the image in the physical matrix through lighting of such members.

In summary, the subject invention is a system for recording a three dimensional image through televised or electronic means that record a three dimensional image at a given location and transmitting the image to a distant location. In order to accomplish this task, the three dimensional object is positioned under an overhead sensor system which comprises in part of a plurality of photosensitive members dispersed on the outer and/or peripheral of a base surface member, which sensors are adapted to photometrically record a position, luminosity, and other features, of a three dimensional image. For this purpose each of the sensors would be optimally equipped with a line of sight beam which is directed to a limited area of the three dimensional object. These sensors will be generally disposed evenly around and above three dimensional object to some degree of symmetry. Each sensor will be in turn equipped with means to record a part of an image, and will be equipped to direct a beam to the object and have the beam reflected back to the sensor to (1) receive the image, (2) determine the distance to the particular part of the image and (3) other data including luminosity. Once the image is received, then the sensor is transmitted to a distant receiver which in turn reflects the image.

This data is directed to a computer which processes the data and sends signals to one or more light emitting diodes disposed in a wire based matrix of three dimensions on which selected diodes are placed in this matrix to replicate the three dimensional image by such selected lights in the matrix.

In the matrix context, in general for the quantitative measurement of directivity in the context of this three dimensional matrix, a photomultiplier tube mounted on a rotation mechanism can be used as one as one means to ascertain X-Y-Z coordinates for matrix input. The measured light intensity is given to the Y input of an X-Y-Z recorder, whereas a voltage from the potentionmeter gauged with the rotation mechanism provides the X input. The sample is also mounted on another rotation mechanism to vary the incident angle of the light beam.

### DESCRIPTION OF SPECIFIC EMBODIMENT

In describing the preferred embodiment of the subject invention, it is important to stress that the following descriptions one particular embodiment and that such a limited description shall not be considered as limiting the scope of the claims of the subject invention. Such a description of a preferred embodiment shall not be considered as limiting the scope of the subject invention to just one such embodiment and the claim shall not be so limited.

The subject apparatus is a three dimensional imaging system adapted to capture an actual object image from one location to be transmitted to a remote location for a continuous duplication of such image at a remote location, generally comprising an electrical system of light sensors dispersed above and laterally relative to the actual object to be photographed, such sensors being adapted to detect and sense the location, movement, shape and coloration and other attributes of the object image, each such sensors being capable of capturing a distinct and different aspect or feature of the actual object. The sensory and reproduction means at a distant location is equipped with an electrical means to detect and relay a sensual signal to a three dimensional physical matrix of lighted means to capture the image in the physical matrix through lighting of such members.

In summary, the subject invention is a system for recording a three dimensional image through televised or electronic means that record a three dimensional image at a given location and transmitting the image to a distant location. In order to accomplish this task, the three dimensional object is positioned under an overhead sensor system which comprises in part of a plurality of photosensitive members dispersed on the outer and/or upper peripheral area of a base surface member, which sensors are adapted to photometrically record a position, luminosity, and other features, of a three dimensional image. For this purpose each of the sensors would be optimally equipped with a line of sight beam which is directed to a limited area of the three dimensional object. These sensors will be generally dispose evenly around the object to some degree of symmetry. Each sensor will be in turn equipped with means to record a part of an image, and will be equipped to direct a beam to the object and have the beam reflected back to the sensor to (1) receive the image, (2) determine the distance to the particular part of the image and (3) other data including luminosity. Once the image is received, then the sensor is transmitted to a distant receiver which in turn reflects the image.

This data is directed to a computer which processes the data and sends signals to one or more light emitting diodes disposed in a wire based matrix of three dimensions on which selected diodes are placed in this matrix to replicate the three dimensional image by such selected lights in the matrix.

In general for the quantitative measurement of directivity in this matrix of sensors, a photomultiplier tube 5 mounted on a rotation mechanism can be used as one as one means to ascertain X-Y-Z coordinates. The measured light intensity is given to the Y input of an X-Y-Z recorder, whereas a voltage from the potentionmeter gauged with the rotation mechanism provides the X input. The sample is also mounted on another rotation mechanism to vary the incident angle of the light beam.

The subject apparatus is a three dimensional imaging system adapted to capture an actual object image from one location to be transmitted to a remote location for a continuous duplication of such image at a remote location, generally comprising an electrical system of light sensors dispersed above and laterally relative to the actual object to be photographed, such sensors being adapted to detect and sense the location, movement, shape and coloration and other attributes of the object image, each such sensors being capable of capturing a distinct and different aspect or feature of the actual object. The sensory and reproduction means at a distant location is equipped with an electrical means to detect and relay a sensed signal to a three dimensional physical matrix of lighted means to capture the image in the physical matrix through lighting of number of such lighted members corresponding to the outer shape characteristics of the three dimensional object.

In summary, the subject invention is a system for recording a three dimensional image through televised or electronic means that record a three dimensional image at a given location and transmitting the image to a distant location. In order to accomplish this task, the three dimensional object is positioned under an overhead sensor system which comprises in part of a plurality of photosensitive members dispersed on the outer peripheral of a base surface member, which sensors are adapted photometrically record a position luminosity and other features, of an image. For this purpose each of the sensors would be optimally equipped with a line of sight beam or a plurality of functional beams which are directed to a limited area of the three dimensional object. These sensors will be generally dispose evenly around the object to some degree of symmetry. Each sensor will be in turn equipped with means to record a part of an image, and will be equipped to direct a beam to the object and have the beam reflected back to the sensor to (1) receive the image, (2) determine the distance to the image and (3) other data. Once the image is received, then the sensor is transmitted to a processor which in turn controls the lighting of certain diodes on the matrix corresponding to the position and outer shape of the three dimensional object.

Alternately stated, the subject apparatus is a three dimensional imaging system adapted to capture an actual object image from one location to be transmitted to a remote location for a continuous duplication of such image at a remote location, generally comprising an electrical system of light sensors dispersed above and laterally relative to the actual object to be photographed, such sensors being adapted to detect and sense the location, movement, shape and coloration and other attributes of the object image, each such sensors being capable of capturing a distinct and different aspect or feature of the actual object. The sensory and reproduction means at a distant location is equipped with an electrical means to detect and relay a sensual signal to a three dimensional physical matrix of lighted means to capture the image in the physical matrix through lighting of certain such members, such as light emitting diodes.

In summary, the subject invention is a system for recording a three dimensional image through televised or electronic means that record a three dimensional image at a given location and transmitting the image to a distant location. In order to accomplish this task, the three dimensional object is positioned under an overhead sensor system which comprises in part of a plurality of photosensitive members dispersed on the outer and/or peripheral of a base surface member, which sensors are adapted to photometrically record a position, luminosity, and other features, of a three dimensional image. For this purpose each of the sensors would be optimally equipped with a line of sight beam which is directed to a limited area of the three dimensional object. These sensors will be generally dispose evenly around the object to some degree of symmetry. Each sensor will be in turn equipped with means to record a part of an image, and will be equipped to direct a beam to the object and have the beam reflected back to the sensor to (1) receive the image, (2) determine the distance to the particular part of the image and (3) other data including luminosity. Once the image is received, then the sensor is transmitted to a distant receiver which in turn reflects the image.

This data is recorded by the sensor and directed to a computer which processes the data and sends signals to one or more light emitting diodes disposed in a wire bound based matrix of three dimensions and which selected diodes in this matrix to replicate the three dimensional image by such selected lights in the matrix.

Moreover, the physical detection mean in this invention may generally use principles of photometry in connection with the numerous, which deals with the calculation and measurement of light. As is well known, photometry is usually concerned with the measurement of luminous intensity of light, color, brightness, absorption factor, spectral distribution and reflective and transmittance. Under generally accepted laws of photometry, photometric measurements are based on the inverse square law and upon Lamert's law of incidence. Further, under the inverse square law of photometry for a given point source of light, the illumination intensity on a surface varies directly and with the luminous intensity of the source and inversely as the square of the distance, between the source and the surface on which the light is to be projected or recorded when the surface is basically perpendicular to the emitted light rays.

This relationship is given by the following formula:
E=I/D2

Where I is the intensity of the light source and D is the distance from the light surface. Thus, if a given ray if projected on a distance surface and one wants to determine the distance to the light source, the above formula is restructured as follows:
D=I/E
Thus E, at a given distance will determine the value of E, (some measurement of the illuminated E) on the source object is still necessary. Therefore, means independently must be used to detect the luminosity of the object at a source. This is particularly important for moving objects to be photographed. If an object is fixed the distance can be pre-measured and distance will be known. Thus in the case of constantly moving object simultaneous dual measurements must be made of both the distance to the portion of the object to be photographed along with the intensity “T” of the light source at the portion of the object. To measure each separately and simultaneously the distance and intensity of the light source at that particular portion of the object being photographed a photomember apparatus may preferably be comprised or integrated with dual units to so perform the task of measuring both light intensity and the distance to the object. With the photometer used to measure the intensity of the light, a transducer is generally integrated therein which receives the impact of the photos of the light impacted on the transducer and thereby transforming the energy imparted on the transducer with electrical current, which current is measured and then conveyed to a computer to process said contact flow of current dependent on the given intensity of light received by the photometer at a given instance—it being understood that the object being photographed is moving from time to time, the intensity of light received will vary and will as the distance varying to the position of the light being photographed. The processing computer unit utilized to process this rapidly changing data needs to be structured to have high processing speed capabilities. For this purpose, the signal generators from the photometer need to be posses rapid pulse capabilities.

Moreover, in order to efficiently and effectively process this ever-changing information constantly impinging on the photometer it is preferable that the photometer transducer be a semiconductor for both rapidly fluctuating light intensifies as well as distances to the portion of the object being continuously photographed. Then applying an electrical potential across the transducer the resulting current flow will be proportional to the intensity of the light being received at a given instance.

As stated simultaneous to the detection of the intensity of light at a given instance there must be a determination at that very instance of the distance to the portion of the object being photographed. For this purpose any distance detection device will suffice so long as it can provide an instant reading to match simultaneously the luminosity intensity reading. For this purpose, use can be made of an integrated low intensity radar device which projects radar signal to the portion of the object being photographed at a given instance. This will provide a simultaneous distance reading to be fed into the computer processing systems, along with other data collected at that very instance by the photometer. The particular multi-functional camera being focused on a portion of the object being photographed will thus have three components focused therein. Simultaneously at a given instance there is a photometric device to measure luminosity and the radar signal will then be transferred into an electronic signal with central computer will have images of light in intensity and distance at a given instance—with these cognitive items to be fed into a processor for transfer to a computer which collects all information from all the sensors.

The transmitted light beams and the radar device used to measure the distance to the position of the object being photographed will be transmitted on a narrow beam to detect a limited part image in a photographic sense. All three projections will be consummated simultaneously at a given instance. It is contemplated that there will be a plurality of such photometric and radar devices each focused on a limited portion of the three dimensional object being photographed, all from different spatial points.

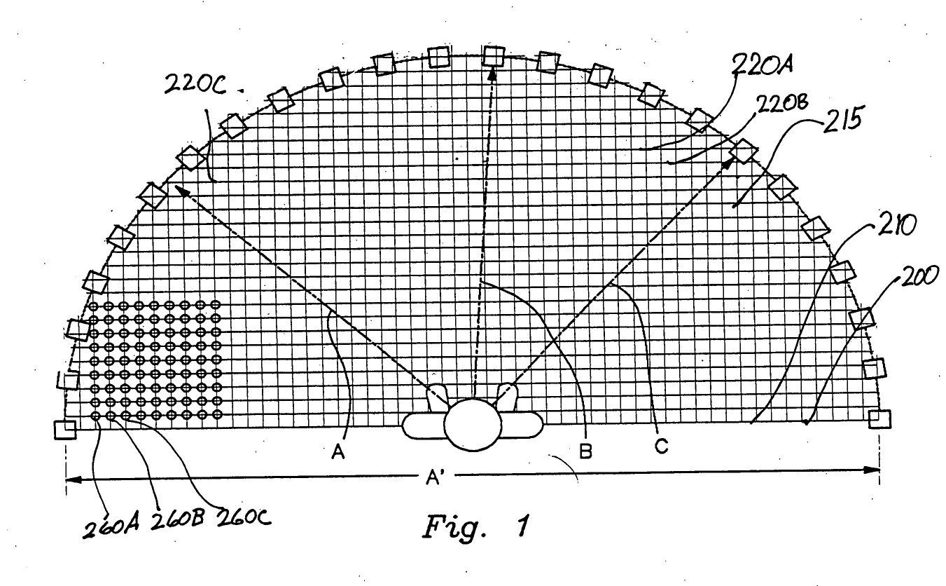

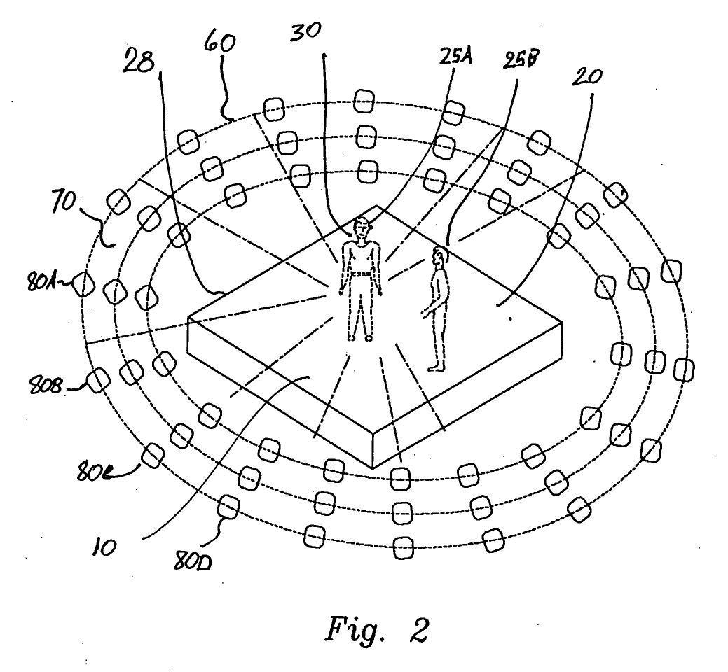

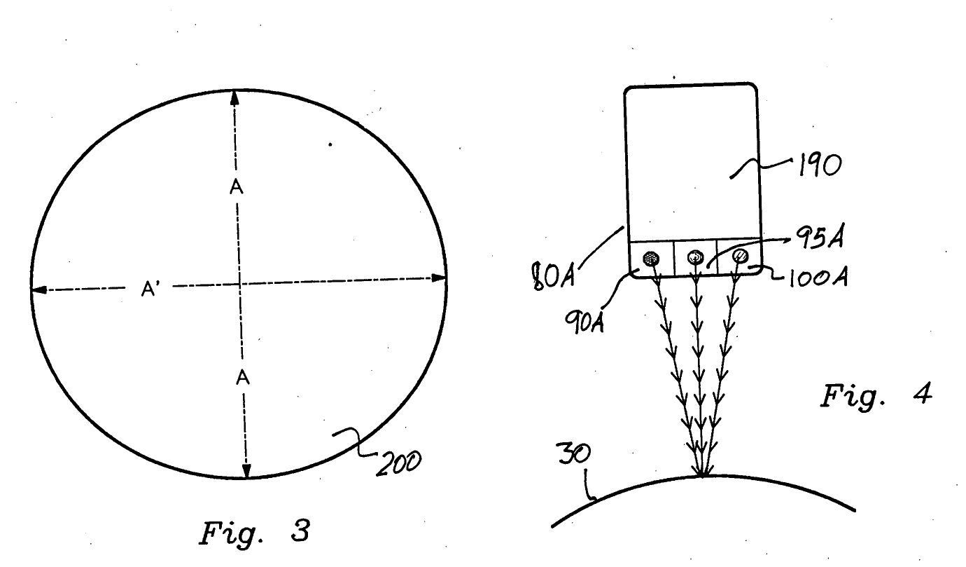

Referring now to the drawings in which one specific embodiment of the subject invention is shown, as using the foregoing principles with particular attention being directed to FIGS. 1 and 2, a base stage area 10 is shown as basically comprising an upper surface 20 area on which a three dimensional object 30 on such upper surface is situated, such three dimensional object being any type of physical object or objects or an individual or individuals which may be in motion on or about such upper surface. Specifically, seen in FIG. 1 is a representation of an individual in motion 25, for example moving from position 25A to position 25B. For this purpose, the upper surface 20 of the stage area is preferably comprised of a flat upper surface, although this feature is not essential to implementation of the subject invention.

As seen in FIGS. 1 and 2, the stage area may have an imaginary outer perimeter bound by marked line 25 as shown in the drawings as being circular, this creating a round surface 30 for such the state area. It is stressed that this latter boundary and shape of the upper surface of the stage as described is optimal for purposes of implementing the concepts of the subject invention can vary. As can be seen as a further optional feature is that the stage area from 20 may have surrounding seats not shown or any other form of seating

As can be further seen in the drawing and FIGS. 1 and 2, in the subject invention suspended or positioned above the upper surface 20 of the base stage is a frame member 60 preferably but not essentially having an undersurface 70 which is concave, However, the shape of the frame member may have a shape or configuration can vary and the undersurface may have other than a concave shape in order to realize the intended result of the invention herein. Disposed on the under portion of such frame member are a plurality of sensor members 80A, 80B . . . dispersed above the stage and more fully explained below. Each sensor members 80A, 80B . . . are tri-parite having photometric members 90A, 90B . . . camera 95A, 95B, . . . and a distance detector radar 100A, 100B . . . these members will record distance information, luminosity, and photographic image each focused on a limited portion of the three dimensional object as more fully set forth below. The data from said sensors will be transferred to a central computer 190.

Utilized in conjunction with the subject invention is a second stage area 200, such second stage area preferably having a flat upper surface 210. This second stage area 200 is the proposed stage in which the object will be recast or shown in three dimensional format. For this purpose disposed in the upper surface 210 of stage 200 will be a matrix 215 or wires with 220A, 220B, 220C extending longitudinally, generally parallel to one another. This matrix 215 is comprised of a plurality of wires 220A, 220B, preferably but not essentially spaced in even intervals from one another, preferably in close proximity. Each will be preferably parallel to one another as seen in FIG. 4. On each wire 220A, 220B will be positioned a plurality of light emitting diodes 260A, 260B, 260C that will emit light if activated by the computer in intensity proportional to the signals received from such computer 190. More particularly the wires 220A, 220B in matrix 215 will be strung evenly and preferably symmetrically over the upper surface of the second base member so extending just above such upper surface preferably in even similar intervals parallel to one another under layers above such surface. Such wires can be strung or positioned in layers or any other arrangement other than parallel as long as such layers provide a converge in even fashion on each wire has a plurality of light emitting diodes even such upper surface. For this purpose, it is preferable that there be multiple wires at given height level all extending parallel at even height from the front of the stage 200 to the back of such stage and that there be multiple strands of such wires at various heights from just above the state surface to the top of the matrix. These light emitting diodes will preferably but not essentially will be spaced at even intervals along the wire on which they are placed.

Sensor members 80A, 80B . . . can be arranged at multiple levels preferably but not necessarily a parabolic pattern above the stage in several circular layers as shown in FIG. 1. These sensors 80A, 80B will preferably comprise of multiple as stated sub-sensors, such as a camera, a distance detection and a photometer, all preferable in a unit. The narrow beams generated by each of the sub-sensors may comprise laser beams or any type of limited beams will necessarily be narrow beams as to focus on a limited area of the object. The camera 85A, 85B will record a limited image of a portion of the three dimensional object. The distance detector 90A, 90B will record the distance to the object at a given point while the photometer 100A, 100B, 100CV will record luminosity. All this data is recorded and transmitted electronically to a central processing computer 190 in the form of a master computer 350.

When the central computer 190 receives a signal each of the sensors 80A, 80B will relay a signal to the wire matrix 215 and activate selected light emitting diodes on a given wire 220A, 220 A that matches the distance and angle calculation from the portion of the object being photographed. The light emitting diodes that are activated apparatus to such distance from the sensor to the object being photographed, will be activated proportional to the strength of the light from the respective sensors will be proportional to the signal received from the photometer for that camera. As stated, there will be several cameras having light emitting codes.

As to the processing system, this particular decoder/display driver is intended for use with a liquid-crystal display (LCD), which is a material in a state halfway between liquid and solid.

If an electric field with transverse lines of force is applied to the liquid crystal the molecules influenced by the filed rearrange themselves parallel to the lines of force, and their twisted structure disappears, with light passing through the liquid crystal is not rotated, so it is blocked by the polarizing filters, and the affected area appears black.

If a field is applied between electrodes on the front and back plates, the electrodes on the front plate can be in any desired form. Each segment is connected to one of the seven outputs of the display driver, and one or more are energized according to the binary input to a ROM decoder, as shown in the truth table in figure S. Obviously there must be a separate deoder for each figure in the readout unless a multiplexer is also provided to switch the figures in rapid succession.

An LCD readout is activated by a square wave with a frequency between 30 and 200 hertz. (If d.c. were used as in other types of display, the liquid crystal would not clear fast enough after removing the voltate.) The frequency is not critical, but if it is lower than 30 hertz a flicker would be evident in the display. Too high a frequency on the other hand would not allow enough time for molecules to ralsin themselves between cycles.

The square wave is applied to the DF IN terminal (DF=display frequency). Its amplitude is not critical because it will be adjusted by the level shifters. The DF OUT signal is applied to the common electrode. Square-wave signals from the display driver that are applied to the segments to be energized have a polarity opposite to the DF OUT signal, so the voltage across the display is doubled. Unactivated segments, on the other hand, are supplied with an in-phase square wave, so the effective voltage across these is zero.

In summary the subject invention is an apparatus for replicating a three dimensional image of an object at a first location and transmitting said three dimensional image to a second location for viewing comprising:

(a) a first base structure having an upper surface which first base structure is placed at a first location;

(b) a three dimensional object disposed on said upper surface of said first base structure with said three dimensional object having a plurality of surfaces portions;

(c) photographing imaging means disposed away from said object on said upper structure, and photographic means comprising a plurality of spaced apart photographic imaging members each adapted to simultaneously photograph one or more surface portions of said three dimensional object at a given instance with each said photographic imaging members having further distance detection means to detect the distance from each photographing imaging means to that portion of the object which is being photographed at the given instance, said distance detection means comprising radar projecting and recovery means;

(d) electronic recording means in the form of a computer to record and store photographic images photographed by each of said photographing imaging means and with said electronic recording means being adapted to record the distance to said photographs of said three dimensional object so photographed;

(e) a second base member being disposed at a second location said second base member having a second base member upper surface;

(f) electrical wire matrix means disposed on said second base upper surface said electronic matrix means comprising a plurality of longitudinally extending wire member disposed above said second base upper surface, each said wire member positioned at a different height level to each other;

(g) a plurality of light emitting diode members disposed along each of said wire members, each of said light emitting diode members being electronically interconnected to said electronic recording means;

(h) electrical means to transmit the stored image distance date to the proper light on the network.

Yet, another summary of the such invention is an apparatus for replicating a three dimensional image of an object at a first location and transmitting said three dimensional image to a second location for viewing comprising:

(a) a first base structure having an upper surface which first base structure is placed at a first location;

(b) a three dimensional object disposed on said upper surface of said first base structure with said three dimensional object having a plurality of surfaces portions;

(c) photographing imaging means disposed away from said object on said upper structure, and photographic means comprising a plurality of spaced apart photographic imaging members each adapted to simultaneously photograph one or more surface portions of said three dimensional object at a given instance with each said photographic imaging members having further distance detection means to detect the distance from each photographing imaging means to that portion of the object which is being photographed at the given instance, said distance detection means comprising radar emissions projecting and return signal receiving means;

(d) electronic recording and processing means in the form of a computer to record and store photographic images photographed by each of said photographing imaging means and with said electronic recording means being adapted to record the light luminosity and distance to said photographic imaging means to said three dimensional object so photographed;

(e) a second base member being disposed at a second location said second base member having a second base member upper surface;

(f) wire matrix means disposed on said second base upper surface said matrix means comprising a plurality of longitudinally extending wire member disposed above said second base upper surface, each said wire member positioned at a different height level to each other;

(g) a plurality of light emitting diode members disposed along each of said wire members, each of said light emitting diode members being electronically interconnected to said electronic recording means to receive signals to each of said light emitting diode members;

(h) electrical means interconnected to each of said light emitting diode members and said electronic recording and processing means to transmit the stored image distance date to the proper light on the network

Additionally in summary of the subject invention is apparatus for replicating a three dimensional image of an object at a first location and transmitting said three dimensional image to a second location for viewing said image in a three dimensional perspective comprising:

(a) a first base structure having an upper surface which first base structure is placed at a first location;

(b) a three dimensional object disposed on said upper surface of said first base structure with said three dimensional object having a plurality of surfaces portions;

(c) these dimensional photographing imaging means disposed away from said three object on said upper surface, said three dimensional photographic means comprising a plurality of spaced apart photographic imaging members each adapted to simultaneously photograph one or more surface portions of said three dimensional object at a given instance, with each said photographic imaging members further having distance detection means to detect the distance from each said photographing imaging means to a said surface portion of said three dimensional object which is being photographed at the given instance, said distance detection means comprising electromagnetic emission means that projected said electromagnetic emission means from said distance detection means to said three dimensional object and having means to receive return electromagnetic emission means signals from said object;

(d) electronic recording and processing means interconnected to said photographic imaging meets at said distance detention means in the form of a computer to record and store photographic images photographed by each of said photographing imaging means and with said electronic recording means being adapted to record the light luminosity and distance to said photographic imaging means to said three dimensional object so photographed;

(e) a second base member being disposed at a second location said second base member having a second base member upper surface;

(f) matrix means disposed on said second base upper surface said matrix means comprising a plurality of longitudinally extending support members disposed above said second base upper surface, each said signal wire member positioned at a different height level to each other;

(g) a plurality of light electrically activated members disposed along each of said wire members, each of said light emitting diode members being electronically interconnected to said electronic recording means to receive signals from said electronic recording to each of said light emitting diode members;

(h) electrical means interconnected to each of said light emitting diode members and said electronic recording and processing means to transmit the stored image distance date to the proper light on the network

1. An apparatus for replicating a three dimensional image of an object at a first location and transmitting said three dimensional image to a second-location for viewing comprising:
(a) a first base structure having an upper surface which first base structure is placed at a first location;
(b) a three dimensional object disposed on said upper surface of said first base structure with said three dimensional object having a plurality of surfaces portions;
(c) photographing imaging means disposed away from said object on said upper structure, and photographic means comprising a plurality of spaced apart photographic imaging members each adapted to simultaneously photograph one or more surface portions of said three dimensional object at a given instance with each said photographic imaging members having further distance detection means to detect the distance from each photographing imaging means to that portion of the object which is being photographed at the given instance, said distance detection means comprising radar projecting and recovery means;
(d) electronic recording means in the form of a computer to record and store photographic images photographed by each of said photographing imaging means and with said electronic recording means being adapted to record the distance to said photographs of said three dimensional object so photographed;
(e) a second base member being disposed at a second location said second base member having a second base member upper surface;
(f) electrical wire matrix means disposed on said second base upper surface said electronic matrix means comprising a plurality of longitudinally extending wire member disposed above said second base upper surface, each said wire member positioned at a different height level to each other;
(g) a plurality of light emitting diode members disposed along each of said wire members, each of said light emitting diode members being electronically interconnected to said electronic recording means;
(h) electrical means to transmit the stored image distance date to the proper light on the network.

2. An apparatus for replicating a three dimensional image of an object at a first location and transmitting said three dimensional image to a second location for viewing comprising:
(a) a first base structure having an upper surface which first base structure is placed at a first location;
(b) a three dimensional object disposed on said upper surface of said first base structure with said three dimensional object having a plurality of surfaces portions;
(c) photographing imaging means disposed away from said object on said upper structure, and photographic means comprising a plurality of spaced apart photographic imaging members each adapted to simultaneously photograph one or more surface portions of said three dimensional object at a given instance with each said photographic imaging members having further distance detection means to detect the distance from each photographing imaging means to that portion of the object which is being photographed at the given instance, said distance detection means comprising radar emissions projecting and return signal receiving means;
(d) electronic recording and processing means in the form of a computer to record and store photographic images photographed by each of said photographing imaging means and with said electronic recording means being adapted to record the light luminosity and distance to said photographic imaging means to said three dimensional object so photographed;
(e) a second base member being disposed at a second location said second base member having a second base member upper surface;
(f) wire matrix means disposed on said second base upper surface said matrix means comprising a plurality of longitudinally extending wire member disposed above said second base upper surface, each said wire member positioned at a different height level to each other;
(g) a plurality of light emitting diode members disposed along each of said wire members, each of said light emitting diode members being electronically interconnected to said electronic recording means to receive signals to each of said light emitting diode members;
(h) electrical means interconnected to each of said light emitting diode members and said electronic recording and processing means to transmit the stored image distance date to the proper light on the network
